(19) United States
(12) Patent Application Publication
(10) Pub. No.: US 2014/0278962 A1
(43) Pub. Date: Sep. 18, 2014

(54) METHOD AND SYSTEM FOR IMPLEMENTING A SALES SYSTEM HAVING A FRIEND OFFER MECHANISM

(71) Applicant: ORACLE INTERNATIONAL CORPORATION, Redwood Shores, CA (US)

(72) Inventor: Christian F. RAUH, Atlanta, GA (US)

(73) Assignee: ORACLE INTERNATIONAL CORPORATION, Redwood Shores, CA (US)

(21) Appl. No.: 13/795,531

(22) Filed: Mar. 12, 2013

(51) Int. Cl. G06Q 30/02; G06Q 50/00

(52) U.S. Cl. CPC G06Q 30/0253; G06Q 50/01
USPC 705/14.51

(57) ABSTRACT

Disclosed is an improved approach to implement a shopping interface that includes a friend offer mechanism which identifies marketing deals that are available as an adjunct to a primary sales situation. The friend offer mechanism presents the additional marketing deals to the consumer. This permits friends offer mechanism to allow the primary consumer to choose a free gift or to purchase another item for a friend at a discount. The invention is applicable to any application in which a product or service to be purchased by a consumer is amenable to be provided to a friend of that purchasing consumer.

### BACKGROUND AND SUMMARY

The present application relates to software development and more specifically to systems, methods, and patterns for implementing order capture software applications.

Many types of business logic are implemented by software applications. For example, software applications often include business logic to perform price quotations and order capture for customers. For the price quotation business logic, a pricing engine may be implemented to receive input data (e.g., product name or product ID) and to return output data that includes the price for each product in the input data. For the order capture business logic, an order capture engine and/or eligibility engine may be used to receive input data regarding a potential order (e.g., customer ID and product ID) and provide output data regarding the order capture or order eligibility.

There are many vehicles that can be used to present order capture business logic to customers. For example, there are many dedicated online shopping sites on the Internet that allow a customer to browse/search for products, and to then purchase the items directly from the shopping site. Many businesses also provide company-specific shopping sites that permit customers to purchase items directly from the business.

With the increasing popularity of social media websites or portals, such as Facebook®, Twitter®, and other such sites, many marketers and businesses have begun to exploit these channels to market and sell their products and services. These portals provide a platform for individual users to interact, and at the same time present organizations with potential marketing tools, such as Facebook® pages, or Twitter® handles, enabling marketers to interact with social media “followers.” Marketers can post messages or advertisements on these social media systems as a way to advertise outside traditional marketing channels. Members, in turn, can respond by clicking on embedded links, replying to the messages, starting posts based on the messages, or performing other site-specific functions. Further, marketers can embed an organization-specific or marketing campaign-specific URL (webpage address) within the messages, driving users and web traffic to a separate web site.

Increasingly, businesses are starting to provide full-fledged shopping experiences through these social media sites. To accomplish this, the business provides a shopping interface through the social media site that allows the user to search and/or browse through a sales catalog, and to place orders for items as desired. The shopping interface also includes mechanisms to implement payment services so that the customer can make payment to complete the order.

The present disclosure is directed to improved approaches to implement a shopping interface that is electronically presented to users. According to some embodiments of the invention, a friend promotional offer mechanism is implemented in the electronic sales system. The friend promotional offer mechanism identifies marketing deals that are available as an adjunct to a primary sales situation and presents the additional marketing deals to the consumer. In some embodiments, the marketing deals provided by the friends promotional offer mechanism allows the primary consumer to choose a free gift or to purchase another item for a friend at a discount. The friend purchase is then posted and/or publicized at a social media site.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE DRAWINGS

FIG. 1 shows a flowchart of a process for implementing a friend promotion mechanism according to some embodiments of the invention.

FIG. 2 illustrates an example system that may be employed according to embodiments of the invention.

FIG. 3 shows a flowchart of an approach to implement the invention according to some embodiments.

FIG. 4 provides an illustrative example according to some embodiments of the invention.

FIG. 5 illustrates an architecture for implementing a shopping application on a social media site according to some embodiments of the invention.

FIG. 6 illustrates an architecture for implementing an administrative module for a shopping application according to some embodiments of the invention.

FIG. 7 illustrates an example system of computing components that may be employed to implement one or more embodiments of the invention.

### DETAILED DESCRIPTION

The present disclosure is directed to improved approaches to implement a shopping interface that is electronically presented to users. According to some embodiments of the invention, a friend promotional offer mechanism is implemented in the electronic sales system. The friend promotional offer mechanism identifies marketing deals that are available as an adjunct to a primary sales situation and presents the additional marketing deals to the consumer. In some embodiments, the marketing deals provided by the friends offer mechanism allows the primary consumer to choose a free gift or to purchase another item for a friend at a discount.

The invention is applicable to any application in which a product or service to be purchased by a consumer is amenable to be provided to a friend of that purchasing consumer. For example, consider the situation where a consumer is shopping at the web storefront for company that is offering a popular electronics product for sale. The consumer decided to purchase the electronics product on the web storefront and adds the item to his shopping cart.

With embodiments of the invention, the sales application now includes a module that checks its database of marketing promotions to determine if a friend promotion applies to the current situation. If so, then a message is displayed to the consumer, indicating that a special reward offer is available to that user, to either get a free gift for a friend or to have an option of purchasing another item at a discount. Assuming that the consumer has decided to take advantage of the offer for a friend, then selection of either the free gift or the discounted purchase causes the additional item to be ordered and for the friend to be notified of the item order using the promotion. The notification is made, for example, by sending a message to the friend or by making a posting to a social media system.

The invention provides numerous advantages to an enterprise. The friend promotional offer mechanism creates more visibility for brands/products offered by the enterprise, as friends that either purchase for someone or provide a free gift will share the situation in a social media timeline. In addition, this creates an automatic viral factor as more social media users see the shared gift purchases to crate increased engagement with the enterprise, its products, and/or its social media presence, which creates even more advocates for that brand/products/enterprise. Moreover, this approach provides an efficient way to reward fans of the enterprise or its products/services at relatively low costs by either giving a slight discount or a free gift to be shared.

FIG. 1 shows a flowchart of an approach to implement the invention according to some embodiments of the invention. At 102, identification is made of a purchase by a consumer. The purchase is made, for example, using a shopping application that is presented electronically to the consumer. The shopping interface may be presented in any medium. For example, the shopping interface may be provided on a web browser to display web pages for a company shopping website or a storefront on a social media page. The purchase occurs by having the consumer select an item from a sales catalog and adding that item to an electronic shopping cart.

A determination is made at 104 whether a friend promotion is available to the user. This action is performed by searching a database of marketing promotions. The marketing promotions may be associated with any aspect of the purchase scenario. For example, the friend promotion may be tied to specific items in the sales catalog. In this approach, identification of items in the shopping cart is used to provide the search key to identify friend promotions in the database of marketing promotions. As another example, the friend promotions may also be tied to specific consumers or to a certain demographic conditions for the consumer. For instance, the friend promotion may be provided to members of a rewards program, to consumers that meet certain threshold levels of purchases, or to consumers that match a given demographic or social profile. The friend promotion may also be available if the consumer enters a valid coupon or discount code into the shopping cart interface. In addition, the friend promotion may also correspond to the specific medium at which the purchase is taking place, e.g., if the enterprise is seeking to increase its social media presence, then the promotion is offered to consumers and/or friends of the consumers that frequent social media sites.

At 106, the friend promotion offer is presented to the consumer. This presentation is made by generating an interface page to be displayed onto a display device accessible by the consumer. For example, a web page can be created that identifies the friend promotion offer, where the web page is displayed in the Internet browser at which the consumer is making the purchase. The displayed web page also includes a mechanism for indicating whether or not the consumer is taking advantage of the friend promotion offer. Various visual buttons may be created on the interface screen that identifies the options to the consumer, e.g., to accept or not accept the offer.

A determination is made at 108 whether the consumer accepting the friend promotion offer. If not, then normal processing is performed for the rest of the purchase scenario, e.g., during the checkout process at 112, shipping and payment information for the just the original items are provided to complete the purchase.

If, however, the consumer agrees to accept the friend promotion offer, then at 110, then the additional items are added to shopping cart. At 112, shipping information is provided for both the friend promotion offer and for the original purchase. Payment information is also provided for the purchase transaction.

Additional options may also be provided for the friend promotion offer at this point. For example, delivery options and/or messaging options can be configured by the consumer for the offer. The messaging options may include any type of suitable message or message delivery mechanism. One example option is to just provide a gift message, which is included with the item delivery to the friend and/or via an electronic system using email or messaging. Another option is to use the power of social media to provide a posting to a social media system, where it is added to the timeline or wall for the friend and/or original consumer.

FIG. 2 illustrates an example system which may be employed in some embodiments of the invention, where the friend offer mechanism 220 comprises a module that is included as part of a shopping application 204. The shopping application 204 comprises any application having business logic for implementing marketing and/or sales activities e.g., to track marketing opportunities, perform price quotations, and/or generate order capture for customers. In some embodiments the shopping application comprises an enterprise application (e.g., a CRM application), or integrates with a back-end enterprise/CRM application on a remote server. For the purposes of illustration and explanation, the present disclosure is described in various embodiments in the context of CRM applications. It is noted, however, that the invention is not limited in its scope to CRM applications, and indeed, may be applied to other types of enterprise applications as well.

In some embodiments, the shopping application 204 generates content that is displayable in a typical web browser, e.g., by providing Hyper Text Markup Language (HTML) content through web pages. The content or data present in each web page can be navigated by the end users using a Graphical User Interface (GUI).

The system includes one or more users at one or more user stations 202 that operate the system to make purchases. The user station 202 comprises any type of computing station that may be used to operate or interface with the system. Examples of such user stations 202 include, for example, workstations, personal computers, or remote computing terminals. The user stations 202 may also be implemented as mobile devices, such as mobile telephones or tablet devices. The user station 202 comprises a display device, such as a display monitor, for displaying a user interface to users. The user station 202 also comprises one or more input devices for the user to provide operational control over the activities of the system, such as a mouse, touchpad or keyboard to manipulate a pointing object in a graphical user interface to generate user inputs.

The shopping application 204 (along with its friend promotion offer module 220) can be implemented as a storefront on a social media system 206. As just one example, the social media system 206 can be the Facebook social media site. In this approach, the shopping application comprises a shop that is established, for example, as a storefront onto the Facebook shopping page for a business or a Facebook page that has been established for a marketing campaign for that business. For the purposes of illustration and explanation, the present disclosure is described in various embodiments in the context of the Facebook social media site. It is noted, however, that the invention is not limited in its scope to just the Facebook social media site, and may be applied to other types of social media as well.

Any suitable approach can be taken to present the content of the shopping application 204 onto an interface for display to the user through social media system 206. One example approach is described in U.S. application Ser. No. 13/018,225, entitled “SYSTEMS AND METHODS FOR CREATING AND INSERTING APPLICATION MEDIA CONTENT INTO SOCIAL MEDIA SYSTEM DISPLAYS”, filed on Jan. 31, 2011, which is hereby incorporated by reference in its entirety.

One or more storage/database systems 216 can be used to implement the system. The one or more storage/database systems 216 includes a sales catalog 210 that contains details about the products/services presented for sale by the system to the user at user station 202. The sales catalog 210 may be accessed, for example, by business logic in the shopping application 204 that performs price quotations and/or capture orders 212 from the customers.

The one or more storage/database systems 216 may also include a promotions database 211. The promotions database 211 contains data pertaining to marketing promotions established by an enterprise for the sales application 204, for items for sale in the sales catalog 210, and/or for customers in the system's customer database (not shown). The existence of applicable friend promotions can be identified by searching through the promotions database 211.

In some embodiments, the one or more storage/database systems 216 are implemented as one or more computer readable storage devices. The computer readable storage device comprises any combination of hardware and software that allows for ready access to the data that is located at the computer readable storage device. For example, the computer readable storage device could be implemented as computer memory operatively managed by an operating system. The computer readable storage device could also be implemented as an electronic database system having storage on persistent and/or non-persistent storage.

FIG. 3 shows a flowchart of an embodiment of the invention where the friend promotion comprises either a free gift or a discount on another purchase. At 302, the sales mechanism checks the shopping cart, e.g., to determine whether the consumer has selected an item for purchase and/or to identify which specific items have been selected for purchase. This action can be taken at the time the consumer adds an item to a shopping cart while the consumer is still in the midst of shopping. Alternatively, this action can be taken when the consumer has already completed shopping, where the consumer has decided to check out of the shopping session.

At 304, a determination is made whether any friend promotions are applicable to the current shopping session. In the current embodiment, this determination is made by checking whether the items in the shopping cart are associated with a friend promotion. A database of marketing promotions maintained by the enterprise can be queried to make this determination, by checking of the existence of any promotions associated with the shopping cart items. As noted above, alternative approaches can also be taken to identify applicable friend promotions. For example, friend promotions may also be implemented that are associated with a given consumer, with a demographic class of consumers, or based upon a coupon/discount code.

If no friend promotions are applicable, then at 330, the process continues without including any friend offers into the current transaction. Therefore, at 332, the consumer will perform a checkout process for the transactions based only on the original items in the shopping cart.

However, if friend promotions are available, then at 306 the identified friend offers are presented to the consumer. The offers in the current embodiment comprise either (a) a free gift for a friend or (b) a discount on a further purchase intended for the friend. For example, a web page can be created that identifies the friend offer, where the web page is displayed in the Internet browser at which the consumer is making the purchase. Any suitable user interface object maybe displayed to the consumer to present the offers and to receive instructions from the user indicating whether any or all of the offers are to be accepted. Visual buttons may be created on the interface screen that identifies the options to the consumer and is clickable to indicate acceptance of the offer.

The indication of an acceptance or not of the friend promotion offer is received from the user at 308. If the user input indicates a refusal of the friend promotion, then the process continues to 330 without including any friend promotion offers into the current transaction, and therefore no additional friend items are added to the shopping cart. At 332, the consumer will perform a checkout process for the transaction based only on the original items in the shopping cart.

If the user input indicates acceptance of the free gift promotion for the friend, then the process continues to 310. If only a single gift option is available, then the free gift is added to the shopping cart at 312, where the item is designated as having zero costs to the consumer. If there are multiple free gift options, then the consumer selects the free gift item (or items) for the friend promotion, where the selected free gift item is placed into the shopping cart.

If the user input indicates acceptance of the option for the discount purchase promotion for the friend, then the process continues to 320. If only a single item purchase option is available, then the item for the discount purchase is added to the shopping cart at 322. If there are multiple item options, then the consumer selects the item (or items) for the friend promotion, where the selected item(s) are placed into the shopping cart. The selected items are placed into the shopping cart with a price that corresponds to the friend promotion discount.

At 314, the consumer will perform a checkout process for the transaction. The transaction will be based on the original items in the shopping cart as well as the additional items resulting from participation in the friend promotion. The checkout process will also allow the system to obtain information for friend that is the beneficiary of the friend promotion, including information necessary for deliver such as name information and delivery information.

Various options may also be configured for notification of the friend purchase option. The notification options may include any type of suitable message or message delivery mechanism. One example option is to just provide a gift message, which is included with the item delivery to the friend or via an electronic system using email or messaging. Another option is to use social media to provide the notification. An example of this approach is to provide a posting for the friend purchase to a social media system, where it is added to the timeline or wall for the friend and/or original consumer. The selected notification approach is implemented at 316.

FIG. 4 provides an illustrative example of the friend promotion mechanism according to some embodiments of the invention. Interface 402 shows an example storefront on a social media site, e.g., a shopping page on Facebook. Numerous items may be available for purchase on the Facebook storefront, such as items X and Y. Interface control features are provided to permit the consumer to select one or more of the available items for purchase. For example, a “Buy” button can be provided to give the consumer an ability to select an item for purchase.

When an item is selected for purchase, then the selected item is placed into a shopping cart. The shopping cart corresponds to a data structure that tracks the items selected for purchase by the consumer. Interface 404 shows an example display of a shopping cart, where the consumer has selected item X for purchase.

In the current embodiment, interface 404 also displays the friend promotions that are available to the consumer. In this example, one displayed promotion pertains to an offer to provide a free gift for a friend. The second displayed promotion pertains to an offer to allow another purchase of the same item at a discount (e.g., 30% discount). Control elements are provided in interface 404 to allow the consumer to select one or more of the available friend promotions.

If the consumer selects the promotion pertaining to the offer for a free item, then a menu 406 may be shown that includes one or more free items for selection. Interface objects may be used to allow the user to select the free item so that the additional item is then placed into the shopping cart. As shown in interface 408, the shopping cart is modified to include the additional item as well as to indicate that the additional item is being added free to the consumer.

If the consumer selects the promotion pertaining to the offer to provide a discount for an additional purchase, then the additional item is placed into the shopping cart. As shown in interface 412, the shopping cart is modified to include the additional item as well as to indicate that the additional item is being purchased at a discount.

The customer then proceeds to checkout for the original item plus any additional item(s) placed into the shopping cart based upon acceptance of a friend promotional offer. Delivery information and payment information may be obtained from the consumer during the checkout process.

The purchase for the friend is then posted to the social media site, e.g., to the Facebook page for the friend onto that friend's timeline. In addition, the friend is provided with an option to further share the purchase with his/her friend, e.g., by sending a message or providing a URL link to a page to share the offer.

FIG. 5 illustrates an architecture 500 that can be used to implement the storefront shopping application 204 according to some embodiments of the invention. This architecture creates interface content for the shopping experience that is displayable through the social media site, e.g., by using an iframe to display the content.

Architecture 500 includes a shop module 502 having mechanisms to implement the shopping process for the user. Module 502 provides the shop infrastructure for the shopping application 204, presenting the user with the shopping interface pages for the store. In addition, module 502 accesses a sales catalog to search for and/or display product/services items for sale to the customer, e.g. by displaying product details to the customer. The shopping cart is also maintained by module 502, where selected purchase items (included friend promotion items) are added to the cart, and unwanted items are removed from the cart.

The shop module 502 is configured to handle friend promotion functionality, e.g., to implement the friend promotion mechanism as described above. Therefore, the processing path for the shop module 502 comprises some or all of the descriptions provided above.

Architecture 500 also includes a checkout module 504 to implement a checkout process for the store application 204. Any suitable checkout processing mechanism can be employed in architecture 500. In some embodiments, the checkout module comprises Spree checkout processing to handle checkout of items in the shopping cart. The checkout process may separately address checkout of hard goods versus checkout of soft goods.

The checkout process is configured to handle friend promotion experiences. Specifically, the checkout process includes options for the user to complete the purchase using the friend promotion approach as described above. Therefore, the processing path for the checkout module 504 comprises some or all of the actions/mechanisms described above.

Payment processing is performed with module 506. This module identifies the specific payment method selected by the user. The module 506 will then interface with an external processing/authorization system to complete the payment process, e.g., by interfacing with Paypal, Authorize.net, and/or Braintree.

The order summary module 508 creates an order summary. The order summary comprises some or all of the pertinent details for the order. For example, for friend purchase promotions, the order summary may include information about the item purchased for the friend, the details of that purchase (e.g., free or at a discount price), delivery options, and/or notification options.

FIG. 6 illustrates an example architecture 600 for administrating the shopping application. The architecture 600 includes an authentication component 620. The authentication component provides a mechanism for implementing authentication functionality for acing and using the administration system. In some embodiments, a secure remote management appliance (SRMa) may be used to implement the authentication component 620.

Administration for the shopping application is provided by the administration module 602. The administration module 602 may be accessed through any suitable entry path. In some embodiments, the administration module 602 is accessed through other administrative consoles 618, e.g., for the console that generally administers additional content for the host social media website (e.g., using the Vitrue Tabs product available from Oracle Corporation of Redwood Shores, Calif.). Alternatively, the administration module 602 may be directly accessed without first traversing another administrative console.

A module setup component 616 may be employed to configure the administrative module 602. This component configures, for example, the identity of the persons that are authorized to access the administrative module 602 and to make administrative changes to the shopping application.

The administration module 602 comprises an overview component 604. The overview component is used to provide analytics for the application. The order component 608 is used to configure parameters for the ordering process at the shopping application. With respect to the friend promotion offers, this component 608 may be used to configure various parameters for allowing the friend promotion to occur.

The catalog component 612 configures the catalog parameters for the shopping application. This component 612 is used, for example, to identify the specific sales catalog data to be accessed by the shopping application.

The promotions component 606 is used to configure the parameters of any marketing promotions to be displayed at and/or used by the shopping application. Such promotions include, for example, any friend promotions that allow for free gifts to friend or that provide a discount for additional items purchases for a friend.

The configuration component 610 is employed to administratively configure various options within the shopping application. The design component 614 permits administrative changes to be made to the design of the shopping application, e.g., to the layout of the shopping page, to select images that are displayed, and to select other items of multimedia to present.

Therefore, what has been described is an improved approach to implement a shopping interface. The friend offer mechanism identifies marketing deals that are available as an adjunct to a primary sales situation and presents the additional marketing deals to the consumer. This permits friends offer mechanism to allow the primary consumer to choose a free gift or to purchase another item for a friend at a discount. The invention is applicable to any application in which a product or service to be purchased by a consumer is amenable to be provided to a friend of that purchasing consumer.

This invention provides numerous advantages to an enterprise. The friend offer mechanism creates more visibility for brands/products offered by the enterprise, as friends that either purchase for someone or provide a free gift will share the situation in a social media timeline. In addition, this creates an automatic viral factor as more social media users see the shared gift purchases to crate increased engagement with the enterprise, its products, and/or its social media presence, which creates even more advocates for that brand/products/enterprise. Moreover, this approach provides an efficient way to reward fans of the enterprise or its products/services at relatively low costs by either giving a slight discount or a free gift to be shared.

### System Architecture Overview

FIG. 7 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to one embodiment of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1415 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution. Data may be stored in a database 1432 on a storage medium 1431 which is accessed through data interface 1433.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

1. A computer implemented method implemented with a processor for a sales system, comprising:
receiving an instruction from a first consumer to add an item to a shopping cart structure on an electronic computing system, wherein the shopping cart structure corresponds to a list of items selected for purchase from the sales system;
identifying a friend promotion offer that is available, wherein the friend promotion offer corresponds to a marketing promotion that provides an additional item to a second consumer;
determining whether the first consumer accepts the friend promotion offer; and
automatically adding an other item to the shopping cart in response to a determination that the first consumer has accepted the friend promotion offer.

2. The method of claim 1, in which the sales system presents a storefront on a social media site.

3. The method of claim 1, wherein the friend promotion offer corresponds to a free gift for the second consumer or a discounted price to purchase the other item.

4. The method of claim 1, wherein the item and the other item are the same good or service.

5. The method of claim 1, further comprising notification of the purchase according to the friend promotion offer.

6. The method of claim 5, in which the notification comprises a posting on a social media site.

7. The method of claim 6, in which the notification updates a timeline for the second consumer.

8. The method of claim 1, in which the friend promotion offer is redistributable by the second consumer.

9. The method of claim 1, in which a marketing database is search to identifying friend promotion offers that are available.

10. The method of claim 9, wherein the friend promotion offer corresponds to the item in the shopping cart, to the first consumer, to a demographic profile, to a social media profile, to a coupon code, to a discount code, or to a shopping medium.

11. A computer program product embodied on a computer usable medium, the computer readable medium having stored thereon a sequence of instructions which, when executed by a processor causes the processor to execute a method for implementing a sales system, the method comprising:
receiving an instruction from a first consumer to add an item to a shopping cart structure on an electronic computing system, wherein the shopping cart structure corresponds to a list of items selected for purchase from the sales system;
identifying a friend promotion offer that is available, wherein the friend promotion offer corresponds to a marketing promotion that provides an additional item to a second consumer;
determining whether the first consumer accepts the friend promotion offer; and
automatically adding an other item to the shopping cart in response to a determination that the first consumer has accepted the friend promotion offer.

12. The computer program product of claim 11, in which the sales system presents a storefront on a social media site.

13. The computer program product of claim 11, wherein the friend promotion offer corresponds to a free gift for the second consumer or a discounted price to purchase the other item.

14. The computer program product of claim 11, wherein the item and the other item are the same good or service.

15. The computer program product of claim 11, wherein the method further comprises notification of the purchase according to the friend promotion offer.

16. The computer program product of claim 15, in which the notification comprises a posting on a social media site.

17. The computer program product of claim 16, in which the notification updates a timeline for the second consumer.

18. The computer program product of claim 11, in which the friend promotion offer is redistributable by the second consumer.

19. The computer program product of claim 11, in which a marketing database is search to identifying friend promotion offers that are available.

20. The computer program product of claim 19, wherein the friend promotion offer corresponds to the item in the shopping cart, to the first consumer, to a demographic profile, to a social media profile, to a coupon code, to a discount code, or to a shopping medium.

21. A sales system, comprising:
a processor;
a co-buy purchase mechanism comprising computer code executed using the processor, in which the computer code implements receiving an instruction from a first consumer to add an item to a shopping cart structure on an electronic computing system, wherein the shopping cart structure corresponds to a list of items selected for purchase from the sales system, identifying a friend promotion offer that is available, wherein the friend promotion offer corresponds to a marketing promotion that provides an additional item to a second consumer, determining whether the first consumer accepts the friend promotion offer, and automatically adding an other item to the shopping cart in response to a determination that the first consumer has accepted the friend promotion offer.

22. The system of claim 21, in which the sales system presents a storefront on a social media site.

23. The system of claim 21, wherein the friend promotion offer corresponds to a free gift for the second consumer or a discounted price to purchase the other item.

24. The system of claim 21, wherein the item and the other item are the same good or service.

25. The system of claim 21, wherein the computer code further implements notification of the purchase according to the friend promotion offer.

26. The system of claim 25, in which the notification comprises a posting on a social media site.

27. The system of claim 26, in which the notification updates a timeline for the second consumer.

28. The system of claim 21, in which the friend promotion offer is redistributable by the second consumer.

29. The system of claim 21, in which a marketing database is search to identifying friend promotion offers that are available.

30. The system of claim 29, wherein the friend promotion offer corresponds to the item in the shopping cart, to the first consumer, to a demographic profile, to a social media profile, to a coupon code, to a discount code, or to a shopping medium.
